(19) United States
(12) Patent Application Publication
(10) Pub. No.: US 2016/0109045 A1
(43) Pub. Date: Apr. 21, 2016

(54) EXHAUST PIPE FOR TURBO ENGINE

(71) Applicant: HYUNDAI MOTOR COMPANY, Seoul (KR)

(72) Inventor: ChunSoon Jang, Hwaseong, Gyeonggi-do (KR)

(21) Appl. No.: 14/811,890

(22) Filed: Jul. 29, 2015

(30) Foreign Application Priority Data
Oct. 17, 2014 (KR) 10-2014-0141162

(51) Int. Cl. F16L 23/00

(52) U.S. Cl. CPC F16L 23/00

(57) ABSTRACT

An exhaust pipe is arranged in a turbo engine for connecting a turbocharger and a warm-up catalytic converter, the exhaust pipe including a flange having an end that is connected to the turbocharger and an inserting portion that is formed at the other end thereof. The exhaust pipe also includes a cone portion which is formed by engaging a lower cone and an upper cone, an inlet formed at a first end of the cone portion where the inserting portion of the flange is inserted and connected by welding along circumference of the inlet, and an outlet formed at a second end of the cone portion where an inlet of the warm-up catalytic converter is connected.

### CROSS-REFERENCE TO RELATED APPLICATION

This application claims under 35 U.S.C. §119(a) the benefit of Korean Patent Application No. 10-2014-0141162 filed in the Korean Intellectual Property Office on Oct. 17, 2014, the entire contents of which are incorporated herein by reference.

### BACKGROUND

(a) Technical Field

The present invention relates to an exhaust pipe for a turbo engine, and more particularly, to the exhaust pipe for connecting a turbocharger and a warm-up catalytic converter so as to reduce welding processes for connecting these elements and improve durability.

(b) Description of the Related Art

Generally, a turbocharger and a warm-up catalytic converter are connected by an exhaust pipe.

Exhaust gas exhausted from an engine flows into the turbocharger and then is supplied from the turbocharger to the warm-up catalytic converter through the exhaust pipe.

The exhaust gas from the warm-up catalytic converter is exhausted through a muffler to outside of a vehicle.

The exhaust pipe is generally connected to a flange by welding.

In particular, an inlet of the exhaust pipe is directly welded to the flange. Thus, a welding portion is exposed to the exhaust gas, and cracks may be formed in the welding portion so that the exhaust gas may be leaked therethrough.

In particular, the exhaust gas exhausted from the turbocharger at a high temperature may cause heat damage to the welding portion of the exhaust pipe and may cause thermal fatigue to form cracks in the welding portion.

The above information disclosed in this Background section is only for enhancement of understanding of the background of the invention and therefore it may contain information that does not form the prior art that is already known in this country to a person of ordinary skill in the art.

### SUMMARY

The present invention provides an exhaust pipe for a turbo engine having advantages of avoiding direct exposure of a welding portion to an exhaust gas so as to prevent heat damage to the welding portion.

In at least one exemplary embodiment of the present invention, an exhaust pipe for a turbo engine connects a turbocharger and a warm-up catalytic converter. The exhaust pipe may include a flange having an end that is connected to the turbocharger and an inserting portion that is formed at the other end thereof; and a cone portion which is formed by engaging a lower cone and an upper cone, the cone portion having an inlet that is formed at a first end of the cone portion where the inserting portion of the flange is inserted thereto and connected by welding along a circumference of the inlet, and an outlet that is formed at a second end thereof where an inlet of the warm-up catalytic converter is connected.

The inlet where the inserting portion of the flange may be inserted thereto is formed at the first end of the lower cone in an ellipse shape, and a stepped portion is formed at the lower cone at a distance from the inlet to the outlet. Further, an insert end inserted into the stepped portion of the lower cone may be formed at the upper cone, and the insert end may be inserted into the stepped portion and an outer circumference of an overlapped portion so as to be welded.

An upper portion of the inserting portion may be more protruded than a lower portion thereof.

At least a part of the insert end may be inserted between the inserting portion and the stepped portion.

A stepped portion may be formed to the lower cone, an insert end inserted into the stepped portion of the lower cone may be formed to the upper cone, the inlet and the outlet may be formed by engaging the upper cone with the lower cone, and the insert end may be inserted into the stepped portion and an outer circumference of an overlapped portion so as to be welded.

An upper portion of the inserting portion may be more protruded than a lower portion thereof.

The flange, the lower cone, and the upper cone may be formed by the same material.

The material may be an austenite material.

### BRIEF DESCRIPTION OF THE DRAWINGS

FIG. 1 is a perspective view of an exhaust pipe for a turbo engine according to a first exemplary embodiment of the present invention.

FIG. 2 is a side exploded view of the exhaust pipe according to the first exemplary embodiment of the present invention.

FIG. 3 is a cross-sectional view along line III-III of FIG. 1.

FIG. 4 is a cross-sectional view along line IV-IV of FIG. 1.

FIG. 5 is a perspective view of an exhaust pipe for a turbo engine according to a second exemplary embodiment of the present invention.

FIG. 6 is a side exploded view of the exhaust pipe according to the second exemplary embodiment of the present invention.

FIG. 7 is a cross-sectional view along line VII-VII of FIG. 5.

### DETAILED DESCRIPTION OF THE EMBODIMENTS

In the following detailed description, only certain exemplary embodiments of the present invention have been shown and described, simply by way of illustration.

The terminology used herein is for the purpose of describing particular embodiments only and is not intended to be limiting of the invention. As used herein, the singular forms “a,” “an” and ^{the} are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

As those skilled in the art would realize, the described embodiments may be modified in various different ways, all without departing from the spirit or scope of the present invention.

A part irrelevant to the description will be omitted to clearly describe the present invention, and the same or similar elements will be designated by the same reference numerals throughout the specification.

In the drawings, the thickness of layers, films, panels, regions, etc., are exaggerated for clarity.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

An exemplary embodiment of the present invention will hereinafter be described in detail with reference to the accompanying drawings.

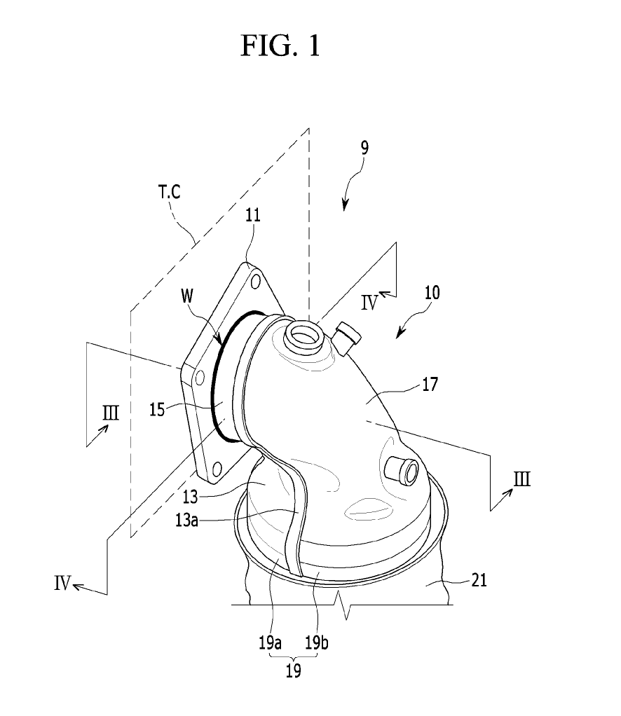

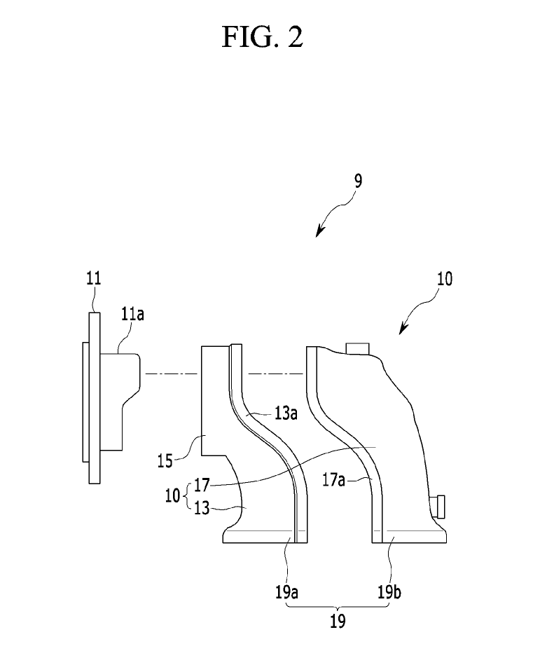

FIG. 1 is a perspective view of an exhaust pipe for a turbo engine according to a first exemplary embodiment of the present invention, and FIG. 2 is a side exploded view of the exhaust pipe according to the first exemplary embodiment of the present invention.

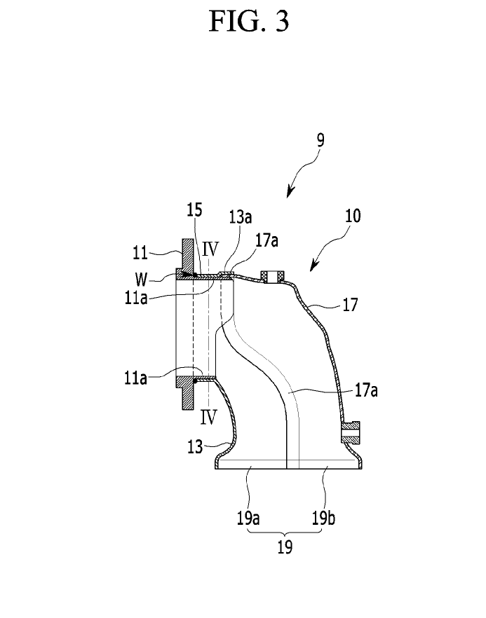

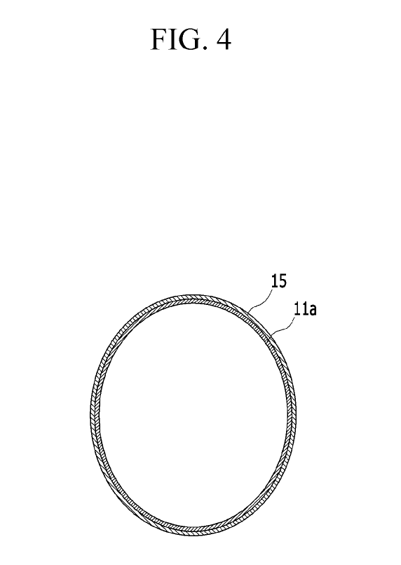

FIG. 3 is a cross-sectional view along line III-III of FIG. 1, and FIG. 4 is a cross-sectional view along line IV-IV of FIG. 1.

Referring to FIGS. 1-4, an exhaust pipe 9 for a turbo engine according to a first exemplary embodiment of the present invention can connect a turbocharger TC and a warm-up catalytic converter 21, and preferably includes a flange 11 and a cone portion 10.

An end of the flange 11 is connected to the turbocharger TC, and an inserting portion 11a is formed at the other end of the flange 11.

The cone portion 10 is formed by engaging a lower cone 13 and an upper cone 17. Also, an inlet 15 with an elliptical shape is formed at a first end of the cone portion 10 where the inserting portion 11a of the flange 11 is inserted thereto, and an outlet 19 is formed at a second end of the cone portion 10 where an inlet of the warm-up catalytic converter 21 is connected thereto.

The elliptical inlet 15 is formed in the first end of the lower cone portion 13 where the inserting portion 11a of the flange 11 is inserted thereto, and a stepped portion 13a is formed in the lower cone 13 at a distance from the inlet 15 to the outlet 19.

Connection of the flange 11 and the cone portion 10 is realized by inserting the inserting portion 11a of the flange 11 into the inlet 15 of the cone portion 10, and by welding an outer circumference of an overlapped portion along circumference W of the inlet 15.

An upper portion of the inserting portion 11a is more protruded than a lower portion thereof.

Thus, thermal stress due to the welding and thermal stress due to exhaust gas may be reduced.

An insert end 17a inserted into the stepped portion 13a of the lower cone 13 is formed in the upper cone 17, and the insert end 17a is inserted into the stepped portion 13a, and an outer circumference of an overlapped portion is welded.

At least a part of the insert end 17a is inserted between the inserting portion 11a and the stepped portion 13a, and thus concentration of thermal stress may be reduced and damage due to vibration may be reduced.

The outlet 19 is formed by a lower cone outlet 19a formed at an end of the lower cone 13, and an upper cone outlet 19b formed at an end of the upper cone 17.

The lower cone 13 and the upper cone 17 may be formed of the same material so that welding process may be easily performed. The material may be an austenite material.

Hereinafter, an exhaust pipe 109 for a turbo engine according to a second exemplary embodiment of the present invention will be discussed.

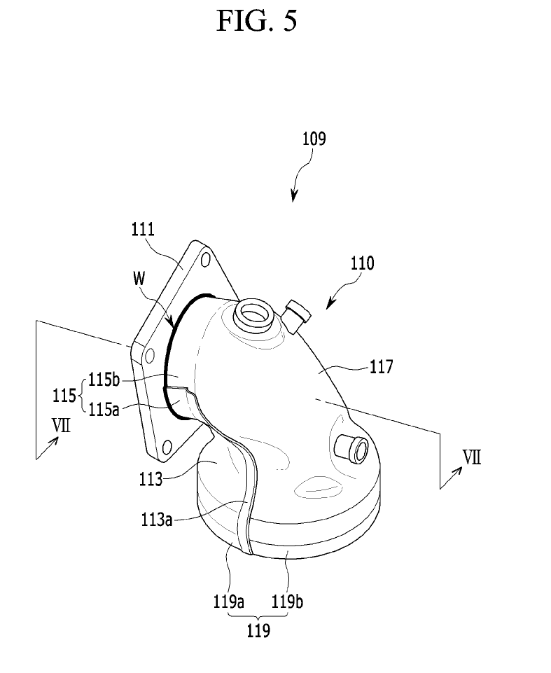

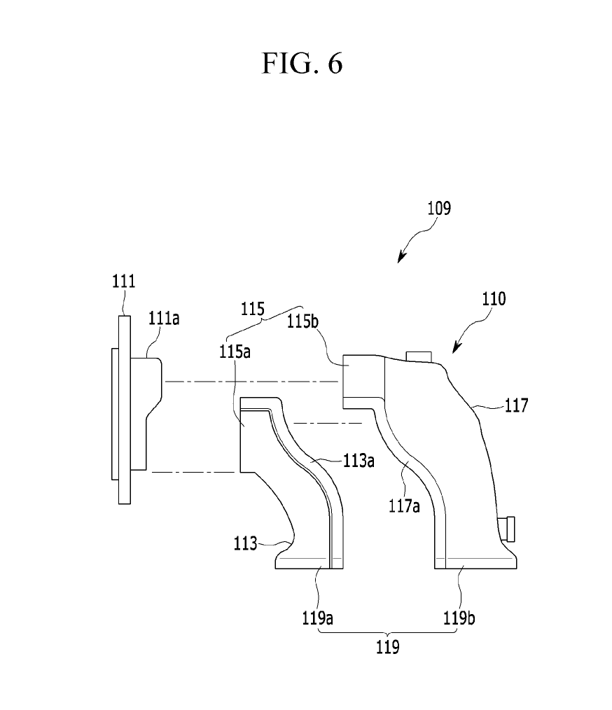

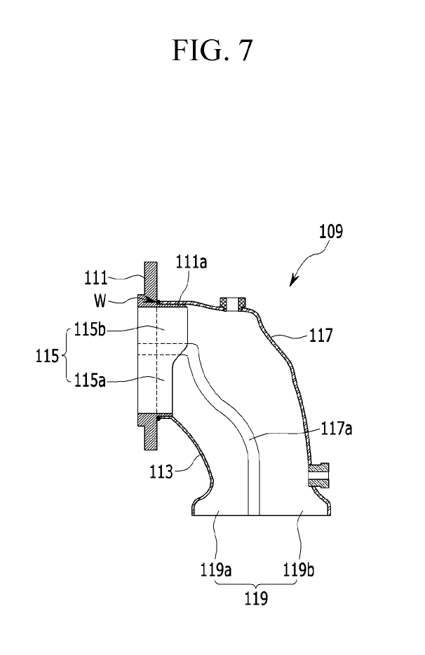

FIG. 5 is a perspective view of an exhaust pipe for a turbo engine according to a second exemplary embodiment of the present invention, FIG. 6 is a side exploded view of an exhaust pipe for a turbo engine according to a second exemplary embodiment of the present invention and FIG. 7 is a cross-sectional view along line VII-VII of FIG. 5.

Referring to FIGS. 5-7, an exhaust pipe 109 for a turbo engine according to a second exemplary embodiment of the present invention includes a flange 111 and a cone portion 110.

The cone portion 110 includes a lower cone 113 and an upper cone 117, and a stepped portion 13a is formed in the lower cone 113 from an inlet 115 to an outlet 119 of the lower cone 113 along an opened portion.

An insert end 117a is formed to the upper cone 117 corresponding to the opened portion of the lower cone 113, the insert end 117a is inserted into the stepped portion 13a, and then an outer circumference of an overlapped portion is welded.

Each end 115a and 115b of the lower cone 113 and the upper cone 117, respectively, form the inlet 115 by engaging the lower cone 113 and the upper cone 117, and an inserting portion 111a of the flange 111 is inserted into the inlet 115.

The outlet 119 is formed by a lower cone outlet 119a and an upper cone outlet 119b formed at the other ends of the lower cone 113 and the upper cone 117, respectively.

An upper portion of the inserting portion 111a is more protruded than a lower portion thereof.

Thus, thermal stress due to the welding and thermal stress due to exhaust gas may be reduced.

In the exemplary embodiments of the present invention, since the inserting portions 11a and 111a of the flanges 11 and 111 are formed as an elliptical shape, thus the welding portions W are increased and may be dispersed. And strength of connection in welding portions W may be enhanced.

Since the inserting portions 11a and 111a of the flanges 11 and 111 are inserted into the inlets 15 and 115 of the cone portions 10 and 110, and then the outer circumferences of the overlapped portion are welded, and the welded portions W are not directly exposed to the exhaust gas with high temperature. So, thermal fatigue in the welding portion W may be reduced and durability may be enhanced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An exhaust pipe for a turbo engine for connecting a turbocharger and a warm-up catalytic converter, the exhaust pipe comprising:
a flange having an end that is connected to the turbocharger, and an inserting portion that is formed at the other end thereof; and
a cone portion which is formed by engaging a lower cone and an upper cone, the cone portion including an inlet that is formed at a first end of the cone portion where the inserting portion of the flange is inserted thereto and connected by welding along a circumference of the inlet, and an outlet that is formed at a second end of the cone portion where an inlet of the warm-up catalytic converter is connected.

2. The exhaust pipe of claim 1, wherein:
the inlet where the inserting portion of the flange is inserted thereto is formed at the first end of the lower cone in an ellipse shape, and a stepped portion is formed in the lower cone at a predetermined distance from the inlet to the outlet;
an insert end inserted into the stepped portion of the lower cone is formed in the upper cone; and
the insert end is inserted into the stepped portion, and an outer circumference of an overlapped portion is welded.

3. The exhaust pipe of claim 2, wherein an upper portion of the inserting portion is more protruded than a lower portion thereof.

4. The exhaust pipe of claim 3, wherein at least a part of the insert end is inserted between the inserting portion and the stepped portion.

5. The exhaust pipe of claim 1, wherein:
a stepped portion is formed in the lower cone;
an insert end inserted into the stepped portion of the lower cone is formed in the upper cone;
the inlet and the outlet are formed by engaging the upper cone with the lower cone; and
the insert end is inserted into the stepped portion, and an outer circumference of an overlapped portion is welded.

6. The exhaust pipe of claim 5, wherein an upper portion of the inserting portion is more protruded than a lower portion thereof.

7. The exhaust pipe of claim 1, wherein the flange, the lower cone and the upper cone are formed of a same material.

8. The exhaust pipe of claim 7, wherein the material is an austenite material.
